(19) United States
(12) Patent Application Publication
(10) Pub. No.: US 2011/0072854 A1
(43) Pub. Date: Mar. 31, 2011

(54) METHOD FOR JOINING MEMBERS TO BE JOINED AND JOINING APPARATUS USED THEREFOR

(76) Inventor: Hideto Nikkuni, Nishinomiya-shi (JP)

(21) Appl. No.: 12/890,346

(22) Filed: Sep. 24, 2010

(30) Foreign Application Priority Data
Sep. 25, 2009 (JP) 2009-220692

(51) Int. Cl. C03B 23/20

(52) U.S. Cl. 65/36; 65/152

(57) ABSTRACT

Provided are a method for joining members to be joined and a joining apparatus used therefor, which can easily and inexpensively join members to be joined such as glass members can be together with good finish.

A joining apparatus 1 adapted to apply a laser beam to a joint interface (laser light absorbent layer 12) between two members to be joined 11a and 11b is provided with: a laser-applying unit 23 for applying a continuous wave laser beam with a focal point thereof spaced a predetermined distance away from the laser light absorbent layer; and a retainer 25 including a pressing portion 51 for applying in a compressing direction a substantially uniform surface pressure to the entire contact surfaces of the two members to be joined 11a, 11b at the time of applying the laser beam. Thus, the members to be joined 11a and 11b are easily and inexpensively joined together with good finish by applying the continuous wave laser beam to the laser light absorbent layer with the focal point thereof spaced the predetermined distance away from the laser light absorbent layer while applying in the compressing direction the substantially uniform surface pressure to the entire contact surfaces of the members to be joined.

### TECHNICAL FIELD

The present invention relates to a method for joining members to be joined and a joining apparatus used therefor.

### BACKGROUND ART

In a display device such as a liquid crystal display and organic electroluminescent display, elements used for image display (such as liquid crystal elements or organic electroluminescence elements) are arranged between two glass members which have been joined and sealed to each other.

These glass members are joined together by, for example, applying a laser beam for fusing the glass members to each other (see, for example, Patent Literature 1).

Patent Literature 1 discloses a method wherein a pulsed laser beam is focused on a laser light absorbing material applied on respective joint surfaces of the two glass members so that heat absorbed by the laser light absorbing material may fuse the glass members to each other. According to the method disclosed in Patent Literature 1, the glass members are joined together under high-temperature atmosphere such as to prevent the production of cracks in a joint between the members to be joined.

### SUMMARY OF THE INVENTION

### Technical Problem

However, the method of Patent Literature 1 employs the pulsed laser beam to join the glass members together under the high temperature atmosphere. The method requires the use of an expensive apparatus equipped with a mirror for converting a continuous wave laser beam to the pulsed laser beam and equipment for maintaining the high temperature atmosphere. Since in the method of Patent Literature 1, the pulsed laser beam is focused on the laser light absorbing material, a range for focusing the pulsed laser beam is limited to the area of the layer formed by the laser light absorbing material which is applied on the joint surface. When the pulsed laser beam is applied, therefore, focusing of the pulsed laser beam requires such high precisions that it may sometimes be difficult to ensure the optimum processing quality.

In view of the foregoing, it is an object of the invention to provide a method for joining members to be joined, and a joining apparatus used therefor, which can easily and inexpensively join members to be joined such as glass members with good finish.

### Solution to Problem

One aspect of the invention is a method for joining members to be joined, comprising the steps:

(A) forming a laser light absorbent layer made of a laser light absorbing material on a joint-side surface of either one of two members to be joined;

(B) overlaying on the laser light absorbent layer of the one member to be joined the other member to be joined;

(C) applying a continuous wave laser beam to the laser light absorbent layer with a focal point thereof spaced a predetermined distance away from the laser light absorbent layer to heat the laser light absorbent layer while applying in a compressing direction a substantially uniform surface pressure to the entire contact surfaces on which the two members to be joined are placed in contact with each other via the laser light absorbent layer, thereby joining the two members to be joined together.

In the joining method of the invention, the continuous wave laser beam is used as the laser light.

Therefore, the members to be joined can be efficiently joined with good finish by applying the continuous wave laser beam with the focal point thereof spaced the predetermined distance away from the laser light absorbent layer, instead of focusing the laser beam on the laser light absorbent layer as in the case where the pulsed laser beam is used as the laser beam.

This is also effective to prevent an excessive laser beam concentration on the laser light absorbent layer and thence overheating of the members to be joined. Accordingly, since the joining method can prevent the members to be joined from sustaining cracks even if the members to be joined are joined together under the normal temperature atmosphere, the joining method can ensure good finish.

Further, in the joining method of the invention, the continuous wave laser beam is applied with the focal point thereof spaced away from the laser light absorbent layer. Therefore, the joining method of the invention provides a wider range for setting the focal point and thence an easier focusing of the laser beam than the conventional method wherein the laser beam is focused on a position in the laser light absorbent layer.

In the joining method of the invention, when the application of the continuous wave laser beam is carried out, the substantially uniform surface pressure is applied in the compressing direction to the entire contact surfaces on which the two members to be joined are placed in contact with each other via the laser light absorbent layer. Accordingly, the heat of the continuous wave laser beam absorbed by the laser light absorbent layer on the one member to be joined is efficiently conducted to the other member to be joined as well. This negates the need for forming the laser light absorbent layers on both of the joint-side surfaces of the members to be joined, resulting in the reduction in the number of process steps.

In the joining method of the invention, a plate member made of glass may be used as the member to be joined.

It is preferred in the joining method of the invention that the continuous wave laser beam is applied to the laser light absorbent layer with a convergence angle thereof set to 2 to 4° and the focal point thereof spaced 4 to 6 mm away from the laser light absorbent layer.

It is also preferred in the joining method of the invention that the continuous wave laser beam is applied to the laser light absorbent layer with a focus spot diameter set to 15 to 25 μm.

It is also preferred that the continuous wave laser beam has a frequency of at least 1000 Hz.

It is also preferred that the continuous wave laser beam has an output power of 17 to 25 W.

It is also preferred in the joining method of the invention that the continuous wave laser beam is applied to the laser light absorbent layer while moving the irradiation position thereof on the laser light absorbent layer at a speed of 10 to 20 mm/s. This ensures that the members to be joined are reliably joined together while the joint therebetween achieves a good joining quality.

Another aspect of the invention is a joining apparatus for joining two members to be joined by applying a laser beam to a laser light absorbent layer made of a laser light absorbing material and interposed at a joint interface between these members to be joined made of a material transmissive for the laser beam, the apparatus comprising: a laser-applying unit for applying a continuous wave laser beam to the laser light absorbent layer with a focal point thereof spaced a predetermined distance away from the laser light absorbent layer; and a retainer for serving to retain the members to be joined and including a pressing portion for applying in a compressing direction a substantially uniform surface pressure to the entire contact surfaces on which the members to be joined are placed in contact with each other via the laser light absorbent layer at the time of applying the laser beam, wherein the retainer is made of a material transmissive for the laser beam.

According to the joining apparatus of the invention, the pressing portion applies in the compressing direction the substantially uniform surface pressure to the entire contact surfaces on which the two members to be joined are placed in contact with each other via the laser light absorbent layer, while the laser-applying unit applies the continuous wave laser beam to the laser light absorbent layer with the focal point thereof spaced the predetermined distance away from the laser light absorbent layer.

Thus, the two members to be joined can be joined together by applying a continuous wave laser beam to the laser light absorbent layer with a focal point thereof spaced a predetermined distance away from the laser light absorbent layer, to heat the laser light absorbent layer, while applying in a compressing direction a substantially uniform surface pressure to the entire contact surfaces on which the two members to be joined are placed in contact with each other via the laser light absorbent layer.

Accordingly, the joining apparatus of the invention affords the same working effects as the above-described joining method.

### ADVANTAGEOUS EFFECTS OF INVENTION

By the joining method for members to be joined and the joining apparatus used therefor according to the invention, the members to be joined such as glass members can be easily and inexpensively joined together with good finish.

### BRIEF DESCRIPTION OF DRAWINGS

FIG. 1 is a front view illustrating an arrangement of a joining apparatus according to one embodiment of the invention.

FIG. 2 is a schematic diagram illustrating an arrangement of a laser oscillator of the joining apparatus according to the one embodiment of the invention.

FIG. 3 is a side view illustrating the arrangement of the joining apparatus according to the one embodiment of the invention.

FIG. 4 is an explanatory diagrams showing operating states of the joining apparatus according to the one embodiment of the invention during application of a laser beam.

FIG. 5 is a schematic diagram illustrating an arrangement of a retainer of the joining apparatus according to the one embodiment of the invention.

FIG. 6 is a process chart showing the process steps of a method for joining members to joined according to one embodiment of the invention.

FIG. 7 is a diagram illustrating a mode of applying the laser beam for joining the members to be joined together in the method for joining members to be joined according to the one embodiment of the invention.

FIG. 8 is a diagram illustrating a mode of moving a irradiation position of the laser beam for joining the members to be joined together in the method for joining members to be joined according to the one embodiment of the invention.

FIG. 9 is a schematic diagram illustrating an arrangement of a fiber laser oscillator of a joining apparatus according to another embodiment of the invention.

FIG. 10(a) shows a drawing-substituting photograph of an optical microscopic image showing a surface of a corner region of a joint of a typical example (Experimental Number:8) of the samples obtained in Experimental Example 1; FIG. 10(b) showing a drawing-substituting photograph of an optical microscopic image showing a surface of a side portion of the joint; and FIG. 10(c) showing a drawing-substituting photograph of an optical microscopic image showing a cross-section of the joint taken in the thicknesswise direction thereof.

### DESCRIPTION OF EMBODIMENTS

### Arrangement of Joining Apparatus for Members to be Joined

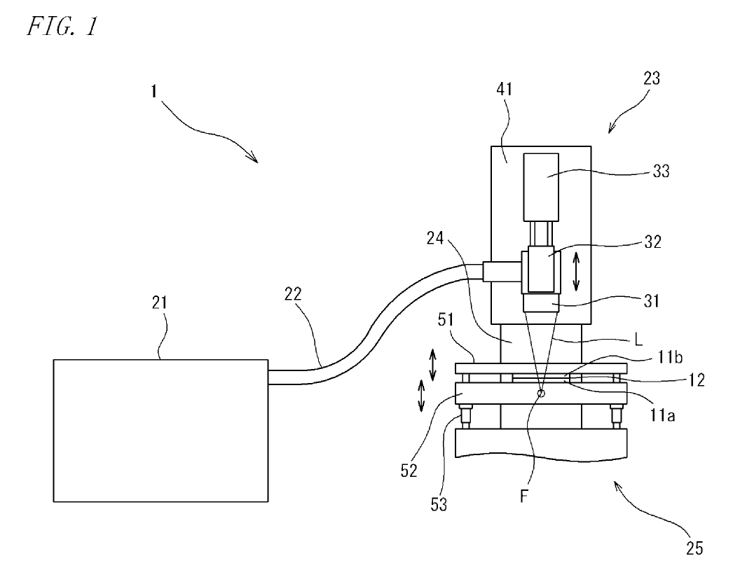

A joining apparatus for members to be joined according to one embodiment of the invention will be described below with reference to the accompanying drawings. FIG. 1 is a schematic diagram illustrating an arrangement of the joining apparatus for members to be joined according to the one embodiment of the invention. The following description is made on, by way of example, an apparatus for joining plate members made of glass (hereinafter, referred to as “glass members”) for use in liquid crystal panels and the like.

The joining apparatus 1 according to the embodiment includes: a laser oscillator 21 for oscillating a continuous wave laser beam; an optical fiber 22 for transmitting the continuous wave laser beam; a laser-applying unit 23 for applying the continuous wave laser beam to a laser light absorbent layer 12 with a focal point thereof spaced a predetermined distance away from a joint interface between glass members 11a and 11b (namely, the laser light absorbent layer 12); an arm portion 24 for movably retaining the laser-applying unit 23; and a retainer 25 for holding the glass members 11a and 11b.

The term “continuous wave laser beam”, as used herein, includes not only a laser beam of which output is continuous but also a laser beam oscillated by continuously operating an excitation source and having a frequency of at least 1000 Hz and a pulse width of less than 0.1 ms (e.g., 15 ns).

According to the joining apparatus 1 shown in FIG. 1, the laser-applying unit 23 is located above the retainer 25.

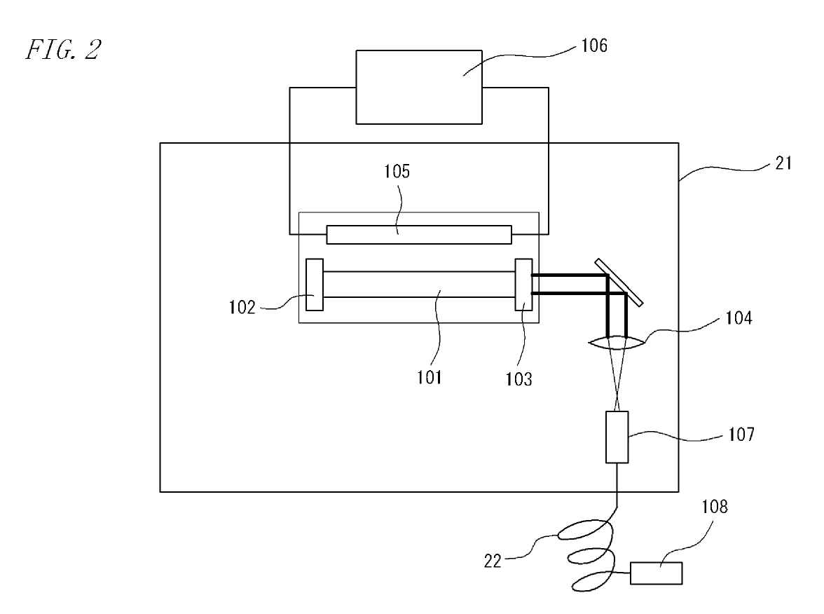

As shown in FIG. 2, the laser oscillator 21 includes: a YAG laser rod 101, a rear mirror 102 for totally reflecting the laser beam, a front mirror 103 for partially reflecting the laser beam, a lens 104 for focusing the laser beam outputted from the front mirror 103, an excitation light source 105 for generating an excitation beam, and a power supply 106 for the excitation light source 105.

The laser oscillator 21 is normally provided with a cooling device for cooling the YAG laser rod 101 and the excitation light source 105. However, the figure does not depict the cooling device for simplicity.

The YAG laser rod 101 is composed of a laser crystal obtained by doping a Y₃Al₅O₁₂ base crystalline matrix with neodymium ions. The YAG laser rod 101 is excited by the excitation beam thereby generating radiation beams.

The YAG laser rod 101 is provided with the rear mirror 102 at one axial end thereof and with the front mirror 103 at the other axial end thereof.

In the laser oscillator 21, the power supply 106 applies a continuous voltage to the excitation light source 105 which, in turn, outputs the excitation beam. This excitation beam excites the YAG laser rod 101 which, in turn, outputs the radiation beams in different directions. Some of the radiation beams travel parallel to the axis of the YAG laser rod 101 in which the incident beams are repeatedly reciprocated between the rear mirror 102 and the front mirror 103 and amplified by induced emission. Thus, the laser beam is oscillated by the laser oscillator 21.

The laser beam is extracted by the front mirror 103 and focused by the lens 104.

The lens 104 is aligned with a light-incident portion 107 such that the focused laser beam may become incident on the light-incident portion 107 connected to one end of the optical fiber 22. Thus, the laser beam incident on the light-incident portion 107 is transmitted through the optical fiber 22 to an output portion 108.

The laser-applying unit 23 includes: an working head 31 for applying the laser beam from the output portion 108 to the laser light absorbent layer 12 interposed between the glass members 11a and 11b; a holder 32 for retaining the working head 31; and a focus adjuster 33 for retaining the holder 32 in a vertically movable manner so as to control the focal position of the laser beam. Since the laser-applying unit 23 is arranged as described above, the laser-applying unit 23 is capable of applying the continuous wave laser beam to the joint interface with the focal point thereof spaced the predetermined distance away from the laser light absorbent layer.

The working head 31 is connected with the output portion 108. The working head 31 includes a lens (not shown) for focusing the continuous wave laser beam transmitted thereto via the optical fiber.

The working head 31 is vertically movably retained by the holder 32. Further, the holder 32 is vertically movably retained by the focus adjuster 33.

When setting the focal point of the laser beam, the working head 31 can be reduced in vibrations Since the working head is supported by a slide mechanism portion 34 and the focus adjuster 33.

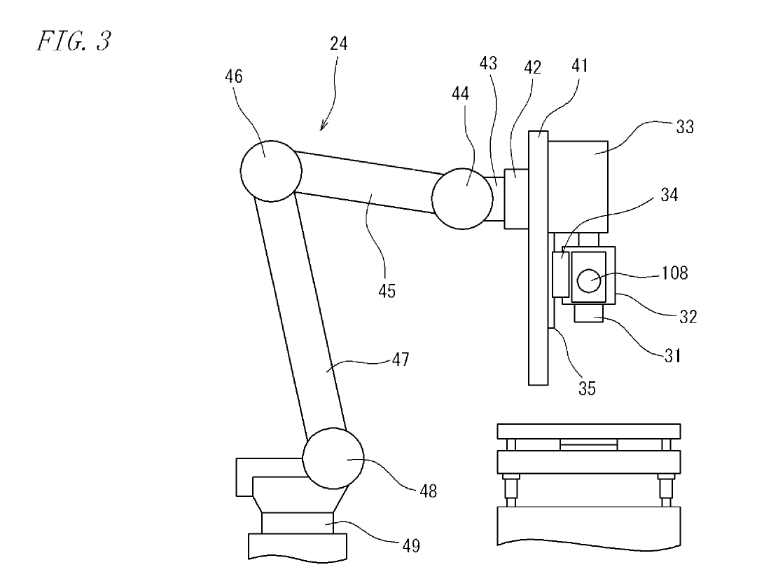

The holder 32 is provided with the slide mechanism portion 34 as shown in FIG. 3. The slide mechanism portion 34 is vertically movably fitted on a guide portion 35 disposed at a distal end portion 41 of the arm portion 24.

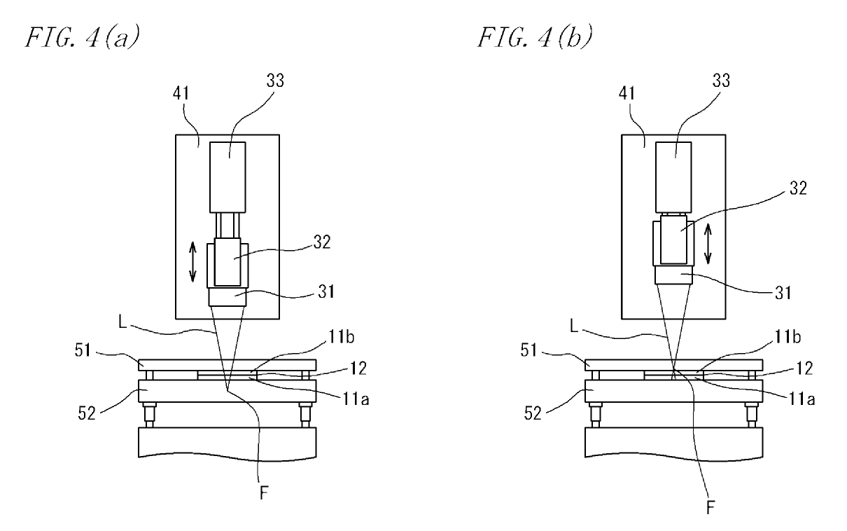

When the glass members 11a and 11b are joined together, the focus adjuster 33 vertically sets the working head 31 to a predetermined position by controlling the vertical position of the holder 32 (see FIG. 4).

When the holder 32 is so controlled as to be set to a downward position, the continuous wave laser beam can be applied to the laser light absorbent layer 12 with the focal point F thereof shifted a predetermined distance downward from the laser light absorbent layer 12 defining the joint interface (see FIG. 4(a)).

When the holder 32 is so controlled as to be set to an upward position, on the other hand, the continuous wave laser beam can be applied to the laser light absorbent layer 12 with the focal point F thereof shifted a predetermined distance upward from the laser light absorbent layer 12 (see FIG. 4(a)).

As shown in FIG. 3, the arm portion 24 forms an articulated arm wherein first, second and third arm bodies 43, 45, 47 are coupled to one another by means of rotary rings 42, 44, 46, 48. The arm portion 24 is designed to align the distal end portion 41 thereof to which the focus adjuster 33 is fixed on the x axis, the y axis and the z axis.

This allows the continuous wave laser beam to be applied continuously to the laser light absorbent layer 12 while moving an irradiation position of the continuous wave laser beam on the laser light absorbent layer 12.

The retainer 25 includes: a pressing portion 51 for applying a surface pressure to the glass members 11a, 11b; and a working table 52 disposed under the pressing portion 51 and putting the glass members 11a, 11b thereon. The pressing portion 51 can be moved up and down by means of a cylinder portion 53.

The pressing portion 51 is so moved as to reduce distance from the working table 52. Thus, a substantially uniform surface pressure can be applied in a compressing direction to the entire contact surfaces on which the glass members 11a, 11b disposed between the pressing portion 51 and the working table 52 are placed in contact with each other via the laser light absorbent layer 1.

The pressing portion 51 includes a portion made of a material (such as glass or quartz glass) transmissive for the laser beam, the portion corresponding to at least an area of the glass members 11a, 11b that is to be irradiated with the laser beam. Therefore, even if the laser beam is applied from above the pressing portion 51, the laser beam is not blocked by the pressing portion 51 and can be applied to the laser light absorbent layer 12.

The joining apparatus of the embodiment controls the laser oscillator 21, laser-applying unit 23 and pressing portion 51 in order that the pressing portion 51 may apply the surface pressure in synchronism with the application of the laser beam by the laser-applying unit 23.

These controls can be provided by a computer or the like.

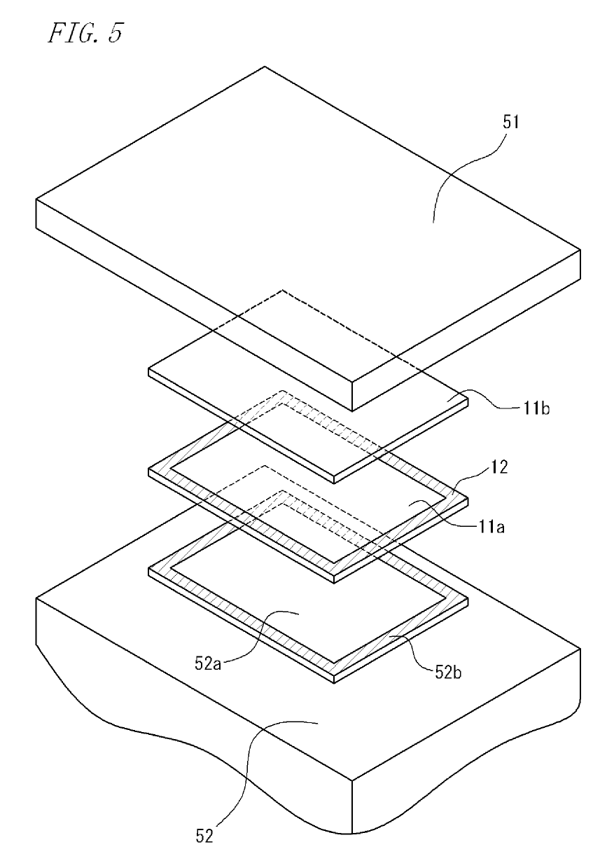

According to the joining apparatus of the embodiment, the working table 52 of the retainer 25 is provided with a ceramic heater 52a on its surface on which the glass members 11a, 11b are placed (see FIG. 5). The ceramic heater 52a is provided with a heat conducting portion 52b for conducting heat from the ceramic heater 52a to the laser light absorbent layer 12 interposed between the glass members 11a and 11b.

The joining apparatus of the embodiment can apply the continuous wave laser beam to the laser light absorbent layer 12 while heating the glass members 11a, 11b thereby preventing the production of cracks in the glass members 11a, 11b.

### (Process Steps of Method for Joining Members to be Joined)

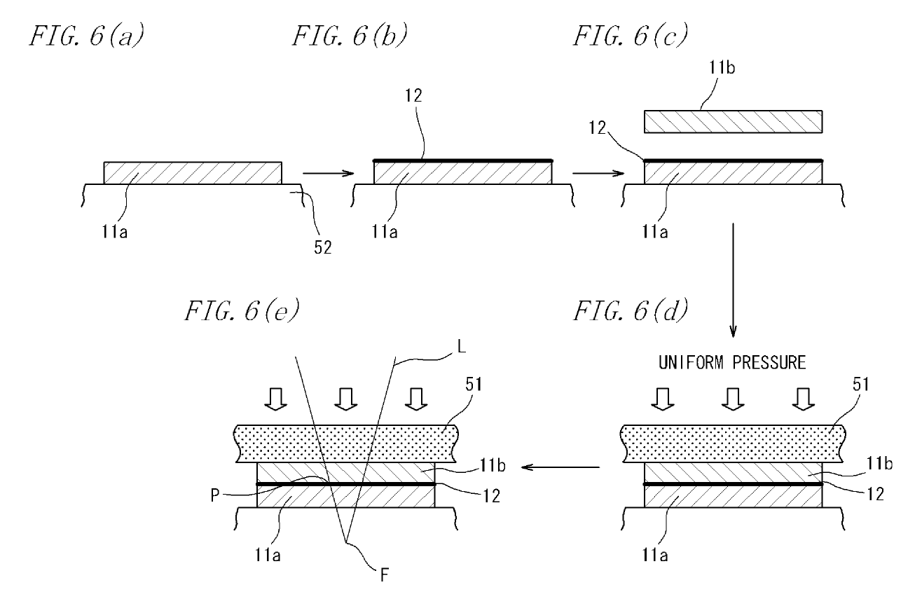

Now, the steps of a method for joining members to be joined according to one embodiment of the invention are described with reference to the accompanying drawings. FIG. 6 is a process chart showing the steps of the method for joining members to be joined according to the one embodiment of the invention. The following description is made on, by way of example, a sequence of steps for joining the glass members for use in liquid crystal panel or the like.

According to the joining method of the embodiment, the glass member 11a is first placed on the working table 52 of the joining apparatus 1 (see FIG. 6(a)). Next, a laser light absorbent layer 12 made of indium tin oxide, a material which absorb laser light having specific wavelength, is formed on a joint-side surface of the glass member 11a (see FIG. 6(b)).

The thickness of the glass member varies depending upon the use of a laminated product of glass members. In the case of the glass member for use in the liquid crystal panel, the thickness of the glass member is, for example, in the range of 0.4 to 1.2 mm.

The laser light absorbent layer 12 can be easily formed by applying indium tin oxide as the laser light absorbing material on the joint-side surface of the glass member 11a, or by vapor-depositing indium tin oxide on the joint-side surface of the glass member 11a.

Such indium tin oxide absorbs the laser light, conducts electricity and exhibits high visible light transmission.

Accordingly, the laminated product including the laser light absorbent layer 12 made of indium tin oxide is suitable for use in display devices such as liquid crystal displays and organic EL displays and in optical devices such as light-receiving devices for optical communication.

This laser light absorbent layer 12 defines the joint interface between the glass members 11a and 11b.

While the thickness of the laser light absorbent layer 12 can be properly defined according to the type of the glass member or the like, the thickness normally ranges between 1 and 20 μm from the viewpoint of efficient absorption of the laser light such as to ensure a sufficient heat for joining the glass members.

The width of the laser light absorbent layer 12 may be properly defined according to the output of the continuous wave laser beam, the size of the glass member and the like.

In the subsequent step of the joining method of the embodiment, the glass member 11b is overlaid on the laser light absorbent layer 12 formed on the glass member 11a (see FIG. 6(c)). In a compressing direction to bring the glass members 11a and 11b closer to each other, a substantially uniform surface pressure is applied to the entire contact surfaces on which the glass members 11a, 11b are placed in contact with each other via the laser light absorbent layer 12 (see FIG. 6(d)).

At this time, a device, an electrode, a spacer or the like may also be interposed between the glass members 11a and 11b according to the use of the resultant laminated product.

The surface pressure may be of a sufficient magnitude to join the glass members 11a and 11b tightly together via the laser light absorbent layer 12.

In the subsequent step of the joining method of the embodiment, the laser light absorbent layer 12 is heated by applying the continuous wave laser beam having appropriate wavelength thereto with the focal point F thereof spaced a predetermined distance away from the laser light absorbent layer 12 while applying the substantially uniform surface pressures to the entire contact surfaces of the glass members 11a, 11b, whereby the glass members 11a and 11b are joined to each other (see FIG. 6E).

The joining method of the embodiment employs the continuous wave laser beam as the laser light and hence, allows for the use of a more inexpensive apparatus than that used in a case where the pulsed laser beam is employed.

The joining method of the embodiment applies the substantially uniform surface pressure to the entire contact surfaces when the continuous wave laser beam is applied. Therefore, the glass members 11a and 11b as the subject to be joined are tightly joined to each other via the laser light absorbent layer 12.

The joining method of the embodiment does not require the laser light absorbent layer 12 to be formed on both of the joint-side surfaces of the glass members as the subject to be joined. Instead, the method permits both of the glass members 11a and 11b to be efficiently heated via a single laser light absorbent layer 12 formed on the joint-side surface of either one of the glass members so that the glass members can be joined to each other.

The joining method of the embodiment can achieve a reduction in the number of steps as compared with the conventional method in which the laser light absorbent layer 12 is formed on both of the joint-side surfaces of the glass members as the subject to be joined.

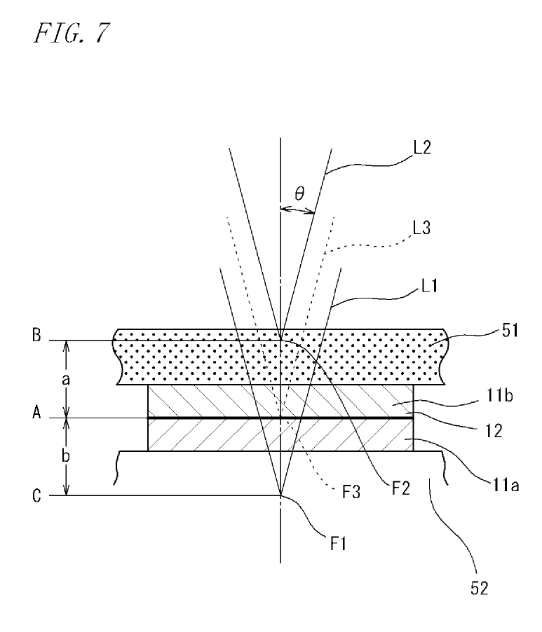

In a case where the laser light absorbent layer is interposed at the joint interface between the two members to be joined so that the glass members 11a and 11b are joined together by applying the laser beam to this laser light absorbent layer, as shown in FIG. 7 it is a conventional practice to set the focal point of the laser beam on the laser light absorbent layer 12 (see a laser beam L3 and a focal point F3 in FIG. 7) from the viewpoint that the laser light absorbent layer is efficiently heated for heating/fusing both of the members. Therefore, the application of the laser beam requires high-precision alignment of the focal point of the laser beam.

According to the joining method of the embodiment, however, the continuous wave laser beam is applied to the laser light absorbent layer 12 as follows. The continuous wave laser beam L1, L2 is applied to the laser light absorbent layer 12 with a focal point F1, F2 thereof spaced a predetermined distance away from the laser light absorbent layer 12. This makes the focus alignment of the laser beam easier than that of the conventional method. Furthermore, the glass members 11a and 11b can be joined together more efficiently and with better finish as compared with the conventional method.

In this process, the focal point of the continuous wave laser beam is set at a position above the retainer 25 and outside the laser light absorbent layer 12. Specifically, the focal point is set at a position above or below the laser light absorbent layer 12 or more preferably at a position above the glass member 11a or below the glass member 11b.

According to the joining method of the embodiment, the continuous wave laser beam may preferably have a convergence angle of 2 to 4° (the angle θ in FIG. 7).

In this case, a distance (distance ‘a’ or ‘b’ in FIG. 7) from the position (position ‘A’ in FIG. 7) of the laser light absorbent layer 12 to the focal point (position ‘B’ or ‘C’ in FIG. 7) may preferably be in the range of 4 to 7 mm.

This permits the laser light absorbent layer 12 to be heated to a temperature level high enough to join the glass members 11a and 11b together while preventing an excessive concentration of the laser beam on the laser light absorbent layer 12.

The continuous wave laser beam may have a wavelength in such a range as to be able to efficiently join the glass members 11a and 11b together. The wavelength of the continuous wave laser beam may preferably be set at a value in the range of 1060 to 1080 nm. For example, the continuous wave laser beam may have a wavelength of 1064 nm or 1075 nm, which is commonly adopted by normal laser oscillators.

While the diameter of the focus spot of the continuous wave laser beam varies depending upon the wavelength thereof, the spot diameter may preferably be in the range of 15 to 25 μm from the viewpoint of efficiently joining the glass members 11a and 11b together.

The continuous wave laser beam may preferably have a frequency of at least 1000 Hz from the viewpoint of more efficient joining of the glass members 11a and 11b with good finish.

The continuous wave laser beam may preferably have an output of 17 W or more from the viewpoint of fully joining the glass members 11a and 11b together. The upper limit of the output of the continuous wave laser beam cannot always be set at a specific value because the maximum output of the laser beam varies depending upon the performance of the laser oscillator. However, the output of the continuous wave laser beam may be limited to 20 W or less.

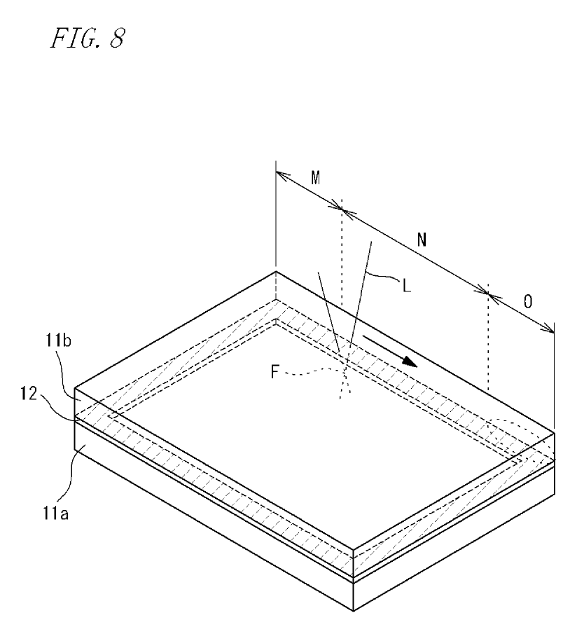

The continuous wave laser beam may preferably provide a lower output in regions M, O (see FIG. 8) in the vicinity of a corner of the laser light absorbent layer 12 than an output in a side region N (see FIG. 8) thereof. This is effective to prevent the crack production in the glass members 11a, 11b.

To join the glass members 11a and 11b together, the continuous wave laser beam can be continuously applied to the laser light absorbent layer 12 while moving the irradiation position thereof on the laser light absorbent layer 12.

The moving speed of the irradiation position of the continuous wave laser beam can be set appropriately according to the output of the continuous wave laser beam, the thermal conductivity or the strength in high temperature of the glass member used. In a case where the output of the continuous wave laser beam is in the range of 17 to 20 W, for example, the moving speed of the irradiation position may be set to 10 mm/s or more, or preferably 11 mm/s or more from the viewpoint of achieving a good joining quality at a joint of the glass members, and set to 15 mm/s or less, or preferably 14 mm/s or less from the viewpoint of ensuring reliable joining. {0051}

### (Other Modifications)

According to the joining apparatus and method of the invention, usable members to be joined may include those which are made of materials transmissive for the laser light, such as glass and quartz.

Laser light absorbing materials, such as transition metals and other alloys, may be used as the material forming the laser light absorbent layer. In this case, the laser light absorbent layer 12 can be formed by applying or vapor-depositing the laser light absorbing material on the joint-side surface of the glass member. Examples of such a laser light absorbing material include molybdenum, ferrum, chromium and the like. Molybdenum is preferred in that it can make the glass members 11a and 11b favorably fused and joined to each other.

According to the joining apparatus of the invention, the laser-applying unit may be disposed under the retainer. In this case, a member corresponding to the working table 52 of the joining apparatus shown in FIG. 1 may be made of the above-described laser light absorbing material.

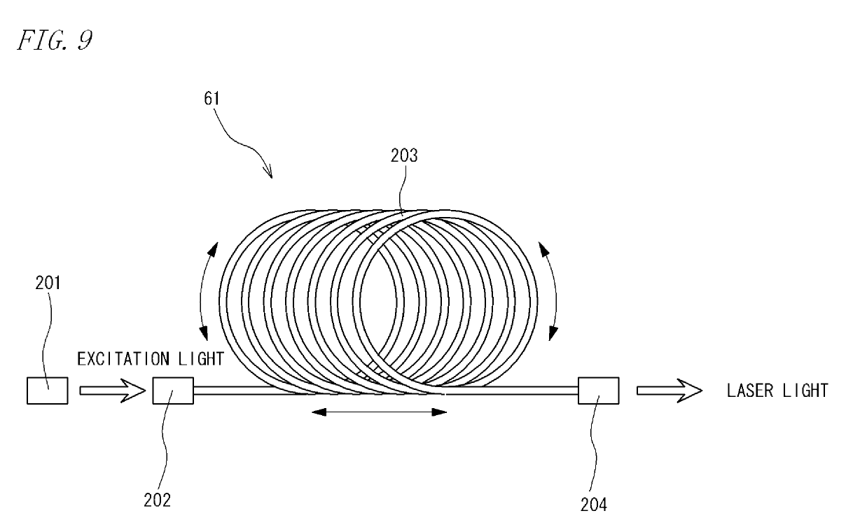

Further, the laser oscillator may be a fiber laser oscillator (see FIG. 9). This fiber laser oscillator 61 includes: an excitation light source 201 for generating an excitation light; a dichroic mirror 202 for incoming the excitation light while reflecting the laser beam (oscillated laser beam); an optical fiber 203 for amplifying the laser beam; and a fiver diffraction grating 204 for passing partially the laser light but reflecting the remaining part of the laser light.

Incidentally, FIG. 9 omits the depiction of a power supply for the excitation light source 201.

According to such a fiber laser oscillator 61, the amplification of the laser beam is carried out in the optical fiber 203. The optical fibers can be bundled and installed in the fiber laser oscillator 61, contributing to the reduction of space to ensure a sufficient length of optical path for amplifying the laser light. Therefore, a further size reduction of the joining apparatus can be achieved by the use of such a fiber laser oscillator 61.

### EXAMPLES

The working effects of the joining apparatus and method of the invention will be examined as below by way the Examples thereof and the like. It is noted however that the invention is not limited by such examples.

### Preparation Example 1

A laser light absorbent layer (thickness: 1 μm, width: 10 μm) was formed by sputtering indium tin oxide or molybdenum on one side surface of a glass member A (alkali-free glass, thickness: 0.7 mm), to give a glass member B.

### Examples 1 and 2

On the retainer 25 of the joining apparatus 1 shown in FIG. 1, the glass member A and the glass member B were overlaid in a manner such that the laser light absorbent layer was between the respective inner sides of these glass members or was interposed at a joint interface between the glass members A and B. In a compressing direction, a substantially uniform surface pressure was applied to the entire contact surfaces on which the glass members A, B were placed in contact with each other via the laser light absorbent layer. Under the load of the above surface pressure and under conditions including a laser-light convergence angle of 2.5°, a laser focus spot diameter of 22 μm and a laser focal point set at a position 5 mm downward from the laser light absorbent layer, a continuous wave YAG laser beam (wavelength: 1064 nm, frequency: 1000 Hz, output: 17 W) was applied to the laser light absorbent layer while moving a irradiation position of the laser beam at a speed of 15 mm/s, whereby the glass members A and B were joined together. The resulting laminated product was used as a sample of Example 1.

A sample of Example 2 was obtained by performing the same operation as that of Example 1, except that the focal point of the laser beam was set at a position 5 mm upward of the laser light absorbent layer.

### Comparative Example 1

The glass members A and B were overlaid in a manner such that the laser light absorbent layer was between the respective inner sides of these glass members or was interposed at a joint interface between the glass members A and B. With the focal point of the laser beam set at a position in the laser light absorbent layer, the same operation as that of Example 1 was performed to give a sample of Comparative Example 1.

### Test Example 1

Each of the samples of Examples 1 and 2 and Comparative Example 1 was observed to check for the presence of joint between the glass members A and B.

As the results, it was confirmed that the samples of Examples 1 and 2 achieved rigid and favorable fusion-joining between the glass members A, B. On the other hand, it was confirmed that the glass members A and B were not joined together in the sample of Comparative Example 1.

It is found from the results that the glass members A, B can be joined together with good finish if the continuous wave YAG laser beam is applied with the focal point thereof shifted 5 mm away from the laser light absorbent layer while applying in the compressing direction the substantially uniform surface pressure to the entire contact surfaces on which the glass members A and B are placed in contact with each other via the laser light absorbent layer.

### Preparation Example 2

A laser light absorbent layer (thickness: 1 μm, width: 10 μm) was formed by sputtering molybdenum on one side surface of a glass member A (alkali-free glass, thickness: 0.4 mm), ti give a glass member C.

### Experimental Example 1

Samples of Experimental Numbers: 1 to 8 were obtained by performing the same operation as that of Example 1 except that the glass member C was used in place of the glass member B and that the respective focal points of the laser beam were set at a position 4 mm downward (−4 mm) from the laser light absorbent layer (Experimental Number: 1); 5 mm downward (−5 mm) from the laser light absorbent layer (Experimental Number: 2); 6 mm downward (−6 mm) from the laser light absorbent layer (Experimental Number: 3); 7 mm downward (−7 mm) from the laser light absorbent layer (Experimental Number: 4); 8 mm downward (−8 mm) from the laser light absorbent layer (Experimental Number: 5); 9 mm downward (−9 mm) from the laser light absorbent layer (Experimental Number: 6); 10 mm downward (−10 mm) from the laser light absorbent layer (Experimental Number: 7); and 6 mm upward (+6 mm) of the laser light absorbent layer (Experimental Number: 8).

The resultant samples were observed with unaided eyes and optical microscope to determine the degree of join between the glass members A and C and the presence or absence of welding trace on the surfaces of the glass members A, C. The results are listed in Table 1. The degree of join between the glass members A and C rates on a scale from “good”, “pass” and “no-good”.

TABLE 1

| | Laser Focus | | | Scan | | Focus | | Welding |
|---|---|---|---|---|---|---|---|---|
| Experimental | Spot Diameter | Output | Frequency | Speed | | Depth | Joint | Trace on |
| Number | (μm) | (W) | (Hz) | (mm/s) | Material | (mm) | Status | Surface |
| 1 | 17 | 17 | 1000 | 15 | Mo | −4 | good | Absence |
| 2 | 17 | 17 | 1000 | 15 | Mo | −5 | good | Absence |
| 3 | 17 | 17 | 1000 | 15 | Mo | −6 | good | Absence |
| 4 | 17 | 17 | 1000 | 15 | Mo | −7 | good | Absence |
| 5 | 17 | 17 | 1000 | 15 | Mo | −8 | pass | Absence |
| 6 | 17 | 17 | 1000 | 15 | Mo | −9 | no-good | Absence |
| 7 | 17 | 17 | 1000 | 15 | Mo | −10 | no-good | Absence |
| 8 | 17 | 17 | 1000 | 15 | Mo | +6 | good | Absence |

As a result shown in Table 1, it is found that the laminated product achieving a good joining condition and free from the welding trace on surface can be obtained when the focal point of the laser beam is spaced 4 to 7 mm away from the laser light absorbent layer (Experimental Numbers: 1 to 4 and 8).

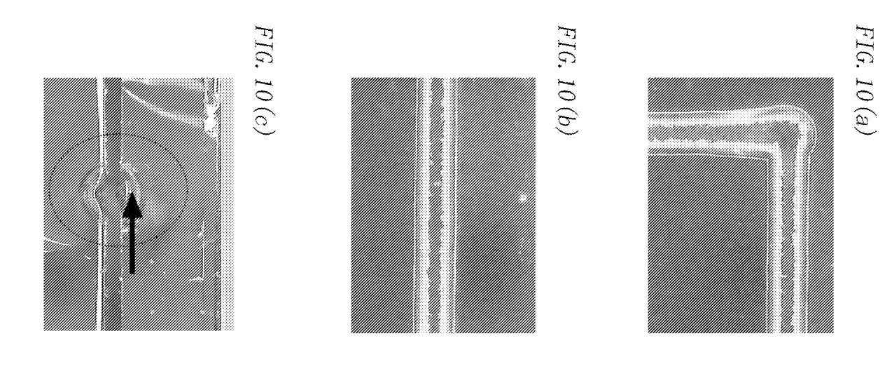

A drawing-substituting photograph of an optical microscopic image showing a surface of a corner region of a joint of a typical example (Experimental Number: 8) of the samples obtained in Experimental Example 1 is shown in FIG. 10(a). A drawing-substituting photograph of an optical microscopic image showing a surface of a side portion of the joint is shown in FIG. 10(b). A drawing-substituting photograph of an optical microscopic image showing a cross-section of the joint taken in the thicknesswise direction thereof is shown in FIG. 10(c).

As a result, as shown in FIG. 10, the sample of Experimental Number: 8 can achieve good finishes at both the corner region of the joint (see FIG. 10(a)) and the side portion of the joint (see FIG. 10(b)). Furthermore, from the result shown in FIG. 10(c), it is found that the glass members are fused at the joint so as to be joined together in good condition (see the portion indicated by an arrow in the figure).

Further, each of the samples of Experimental Numbers: 1 to 4 also achieved as good finishes as Experimental Number: 8.

### Example 3

A sample of Example 3 was obtained by performing the same operation as that of Example 1, except that a continuous wave YAG laser beam having a wavelength of 1075 nm was used in place of the continuous wave YAG laser beam having the wavelength of 1064 nm. Just as in Experimental Example 1, the resulting sample was observed with unaided eyes and optical microscope to determine the degree of join between the glass members A and C, and the presence or absence of welding trace on the surfaces of the glass members A and C.

As a result, it is confirmed that a sample in good joining conditions with a good finish at the joint can be obtained as in the case of Example 1.

### REFERENCE SIGN LIST

1: joining apparatus
11a, 11b: member to be joined, glass member
12: joint interface, laser light absorbent layer
23: laser-applying unit
25: retainer
51: pressing portion

### CITATION LIST

### Patent Literature

{Patent Literature 1} Japanese Unexamined Patent Publication No. 2003-170290

1. A joining method for members to be joined comprising the steps of:
(A) forming a laser light absorbent layer made of a laser light absorbing material on a joint-side surface of either one of two members to be joined;
(B) overlaying on the laser light absorbent layer of the one members to be joined the other member to be tested;
(C) applying a continuous wave laser beam to the laser light absorbent layer with a focal point thereof spaced a predetermined distance away from the laser light absorbent layer, to heat the laser light absorbent layer, while applying in a compressing direction a substantially uniform surface pressure to the entire contact surfaces on which the two members to be joined are placed in contact with each other via the laser light absorbent layer thereby joining the two members to be joined together.

2. The joining method according to claim 1, wherein the member to be joined is a plate member made of glass.

3. The joining method according to claim 1, wherein the continuous wave laser beam is applied to the laser light absorbent layer with a convergence angle thereof set to 2 to 4° and the focal point thereof spaced 4 to 61 nm away from the laser light absorbent layer.

4. The joining method according to claim 1, wherein the continuous wave laser beam is applied to the laser light absorbent layer with a focus spot diameter set to 15 to 25 μm.

5. The joining method according to claim 1, wherein the continuous wave laser beam has a frequency of at least 1000 Hz.

6. The joining method according to claim 1, wherein the continuous wave laser beam has an output of 17 to 25 W.

7. The joining method according to claim 6, wherein the continuous wave laser beam is applied to the laser light absorbent layer while moving a irradiation position thereof on the laser light absorbent layer at a speed of 10 to 20 nm/s.

8. A joining apparatus for joining two members to be joined together by applying a laser beam to a laser light absorbent layer made of a laser light absorbing material and interposed at a joint interface between these members to be joined made of a material transmissive for the laser beam, the apparatus comprising:
a laser-applying unit for applying the continuous wave laser beam to the laser light absorbent layer with a focal point thereof spaced a predetermined distance away from the laser light absorbent layer; and
a retainer for serving to retain the members to be joined and including a pressing portion for applying in a compressing direction a substantially uniform surface pressure to the entire contact surfaces on which the members to be joined are placed in contact with each other via the laser light absorbent layer at the time of applying the laser beam, wherein the retainer is made of a material transmissive for the laser beam.

9. The joining method according to claim 2, wherein the continuous wave laser beam is applied to the laser light absorbent layer with a convergence angle thereof set to 2 to 4° and the focal point thereof spaced 4 to 6 mm away from the laser light absorbent layer.

10. The joining method according to claim 2, wherein the continuous wave laser beam is applied to the laser light absorbent layer with a focus spot diameter set to 15 to 25 μm.

11. The joining method according to claim 3, wherein the continuous wave laser beam is applied to the laser light absorbent layer with a focus spot diameter set to 15 to 25 μm.

12. The joining method according to claim 2, wherein the continuous wave laser beam has a frequency of at least 1000 Hz.

13. The joining method according to claim 3, wherein the continuous wave laser beam has a frequency of at least 1000 Hz.

14. The joining method according to claim 4, wherein the continuous wave laser beam has a frequency of at least 1000 Hz.

15. The joining method according to claim 2, wherein the continuous wave laser beam has an output of 17 to 25 W.

16. The joining method according to claim 3, wherein the continuous wave laser beam has an output of 17 to 25 W.

17. The joining method according to claim 4, wherein the continuous wave laser beam has an output of 17 to 25 W.

18. The joining method according to claim 5, wherein the continuous wave laser beam has an output of 17 to 25 W.

19. The joining method according to claim 15, wherein the continuous wave laser beam is applied to the laser light absorbent layer while moving a irradiation position thereof on the laser light absorbent layer at a speed of 10 to 20 nm/s.

20. The joining method according to claim 16, wherein the continuous wave laser beam is applied to the laser light absorbent layer while moving a irradiation position thereof on the laser light absorbent layer at a speed of 10 to 20 nm/s.
